(19) United States
(12) Patent Application Publication
(10) Pub. No.: US 2006/0162302 A1
(43) Pub. Date: Jul. 27, 2006

(54) Filter for pneumatic tool

(75) Inventor: Timothy E. Terrell, Jackson, TN (US)

Correspondence Address: THE BLACK & DECKER CORPORATION, 701 EAST JOPPA ROAD, TW199, TOWSON, MD, 21286, US

(73) Assignee: Black & Decker Inc., Towson, MD (US)

(21) Appl. No.: 11/335,259

(22) Filed: Jan. 19, 2006

Related U.S. Application Data
(60) Provisional application No. 60/645,633, filed on Jan. 21, 2005.

(51) Int. Cl. B01D 50/00

(52) U.S. Cl. 55/385.1

(57) ABSTRACT

An apparatus and method for retrofitting a pneumatic tool with a filter. The pneumatic tool has an end cap configured to receive a connector for connecting the pneumatic tool to a source of compressed gas. A retrofit connector is adapted to be received by the end cap of the pneumatic tool in place of the connector. A filter is connected to the retrofit connector independent of the end cap, and configured to filter the compressed gas received from the source. The connector has a first mechanical connection, and a second mechanical connection configured to mate with a third mechanical connection disposed on the end cap. The filter includes a fourth mechanical connection configured to mate with the first mechanical connection of the connector.

### CROSS REFERENCE TO RELATED APPLICATIONS

This application claims priority, under 35 U.S.C. § 119(e), to U.S. Provisional Application No. 60/645,633, filed Jan. 21, 2005, which is incorporated herein by reference.

### TECHNICAL FIELD

This application relates to a filter for use with a pneumatic tool.

### BACKGROUND

Pneumatic tools, such as nail guns, power sprayers, air hammers, impact wrenches, are actuated by a source of compressed gas, e.g., from an air compressor. Filters may be employed to filter the compressed gas of impurities, such as oil and dirt, e.g., to inhibit clogging of the pneumatic tool. Existing pneumatic power tools that lack a filter may be used with an external filter that is, e.g., disposed in the compressor or along the air line or hose between the compressor and the pneumatic tool.

Other pneumatic tools may be specially designed to include a filter, such as U.S. Pat. No. 5,637,125 (hereinafter “the '125 patent”), titled “Air Filter Assembly for Pneumatic Tool,” issued Jun. 10, 1997, which is incorporated herein by reference. The '125 patent describes a pneumatic nail gun 11 with a filter 20 that is reproduced in FIG. 1 of this application. Nail gun 11 includes a handle 14 to which is attached a specially designed end cap 15. End cap 15 includes an air supply port 16 with a first threaded portion 18 that receives a connector plug 19 for connection to the compressor, and a second threaded portion for connection to the filter 20. The nail gun 11 disclosed in the '125 patent, thus, requires the use of specially designed end cap 15 for attaching the filter 20 to the nail gun 11. A problem with this design is that nail gun 11 requires a specially designed end cap 15, resulting in, e.g., additional costs.

The prior art does not describe or suggest a way for existing pneumatic tools having standard components to be retrofitted with a filter. It is desirable to provide an apparatus and method that permits existing pneumatic tools to be retrofitted with a filter for filtering compressed gas.

### SUMMARY

This application relates to an apparatus and method for retrofitting an existing pneumatic tool having standard components, e.g., standard end caps, with a filter assembly.

In an aspect, a filter assembly for a pneumatic tool having an end cap configured to receive a connector for connecting the pneumatic tool to a source of compressed gas, includes a retrofit connector and a filter. The retrofit connector is adapted to be received by the end cap of the pneumatic tool in place of the connector. The filter is connected to the retrofit connector independent of the end cap, and configured to filter the compressed gas received from the source.

Implementations of this aspect may include one or more of the following features. The retrofit connector has an external connection portion configured to connect the retrofit connector to the end cap. The external connection portion includes external threads. The retrofit connector has an internal connection portion to which the filter is connected. The internal connection portion includes internal threads. When the filter is connected to the retrofit connector and the retrofit connector is attached to the end cap, the filter is positioned substantially inside of the pneumatic tool. The filter includes a filter disposed inside a casing and a throat portion coupled to the casing. The throat portion is connected to the retrofit connector. A spring member is disposed between the filter and the end cap. The connector includes an extension that extends from the end cap for attachment to a compressed air hose.

In another aspect, a filter assembly for a pneumatic tool having an end cap includes a connector and a filter. The connector is configured to be attached to a source of compressed gas and to the end cap of the pneumatic tool. The connector has a first mechanical connection, and a second mechanical connection configured to mate with a third mechanical connection disposed on the end cap. The filter is configured to filter the compressed gas. The filter includes a fourth mechanical connection configured to mate with the first mechanical connection of the connector.

Implementations of this aspect may include one or more of the following features. The first, second, third, and/or fourth mechanical connections include at least one of a threaded connection, a bayonet connection, a snap-fit connection, a frictional connection, a quick release connection, a spring-biased ball and detent connection, an adhesive connection, a hook-and-loop fastener, a set screw, and a Luer lock. The first mechanical connection is disposed on an inner surface of the connector and the second mechanical connection is disposed on an outer surface of the connector. The filter includes a filter media that includes one or more of sintered semi-spherical polymer granule, porous semi-spherical polymer granule, fibrous mesh, paper mesh and gauze. The filter includes a combination of course and fine filter media. The combination of course and fine filter media includes particles having a size between approximately 10 microns and approximately 40 microns. The connector includes a fifth mechanical connection configured to be attached to a hose from the compressed gas source.

In another aspect, a pneumatic tool includes a housing containing a pneumatically driven engine. A handle extends from the housing and includes an inlet for delivering compressed air to the engine. An end cap is removably coupled to the handle and has an aperture therethrough in fluid communication with the inlet. A connector is configured to deliver compressed gas to the engine. The connector is received in the aperture and has a first mechanical connection. The connector has a second mechanical connection configured to mate with a third mechanical connection disposed on the end cap. A filter is configured to filter the compressed gas. The filter includes a fourth mechanical connection configured to mate with the first mechanical connection of the connector. A trigger is located adjacent to the handle. A nosepiece is coupled to the housing. A magazine for containing a plurality of fasteners is coupled to the nosepiece and to at least one of the handle and the housing. When the trigger is actuated, compressed air flows through the connector, the filter, and the inlet to actuate the engine, which drives one or more of the plurality of fasteners through the nosepiece.

In another aspect, a method of retrofitting a pneumatic tool includes: removing an end cap of the pneumatic tool, removing an existing connector from the end cap of the pneumatic tool, attaching a filter assembly that includes a retrofit connector in communication with a filter to the end cap in place of the existing connector, and replacing the end cap on the pneumatic tool. In an implementation, the filter assembly is attached by attaching the retrofit connector to the end cap in place of the existing connector and attaching the filter to the retrofit connector.

Advantages include at least the following. The apparatus and method allows a pneumatic tool that lacks a filter to be retrofitted with a filter. In addition, no specially-designed end cap is required, such that the apparatus works with virtually any end cap for a pneumatic tool. Further, the apparatus and method results in substantial cost savings, such as by not requiring a specialized end-cap and by allowing existing pneumatic tools to be retrofitted with filters, rather than being replaced. Other advantages and features will be apparent from the description, the drawings, and the claims.

### BRIEF DESCRIPTION OF THE DRAWINGS

FIG. 1 is a partially cutaway side view of the nail gun described in the '125 patent.

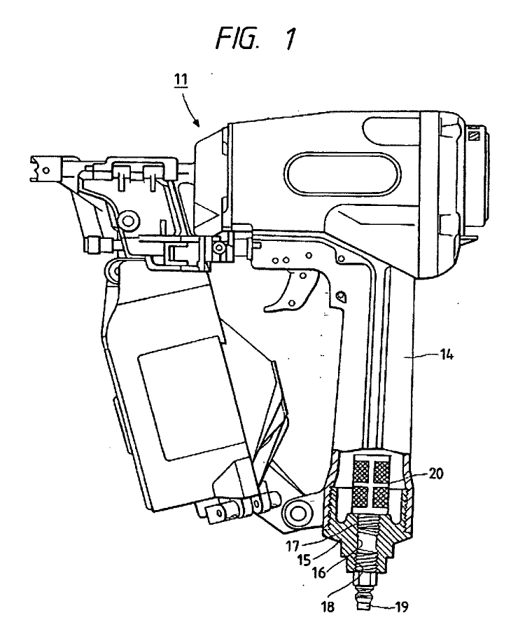

FIG. 2 is a partially cutaway side view of an embodiment of a pneumatic tool without a filter.

FIG. 3 is a partially cutaway side view of the pneumatic tool of FIG. 2 retrofitted with an embodiment of a filter assembly.

FIG. 4 is an enlarged view of the cutaway portion of the filter assembly of FIG. 3.

### DETAILED DESCRIPTION

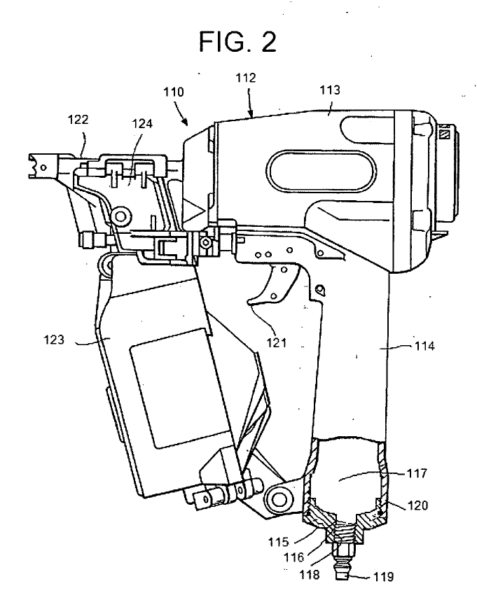

FIG. 2 shows an implementation of a pneumatic tool 110 that does not have a filter. Tool 110 includes a body 112 with a housing 113 and a handle 114. Housing 113 includes a pneumatically driven engine (not shown), e.g., a reciprocating piston in a cylinder such as that described in U.S. Pat. No. 6,772,931, titled “Magazine Assembly for Fastening Tool,” (“the '931 patent”) which is incorporated herein by reference. Handle 114 includes an inlet cavity 117 for delivering compressed air to the engine.

Threadably coupled to an end portion 120 of handle 114 is an end cap 115 with an aperture 116 in communication with inlet cavity 117 for delivering compressed air to the inlet 117. The aperture 116 includes a female threaded portion 118 in which is threaded a hose connector 119. Tool 110 also includes a trigger 121 disposed adjacent handle 114, a nosepiece 122 coupled to the housing 113, a magazine 123 containing a plurality of fasteners and coupled to the nosepiece 122 and to the handle 114, and a fastener supply mechanism 124 disposed between the magazine 123 and the nosepiece 122.

In use, an air compressor (not shown) is connected to the hose connector 119 through a hose (not shown). When trigger 121 is actuated, a trigger valve (not shown) and a main valve (not shown) within the housing 113 are opened to cause the compressed air to drive the engine in the housing 113. As a result, a fastener, e.g., a nail or staple, is ejected from nosepiece 122. The fasteners are stored in the magazine 123 and delivered to the nosepiece for ejection by the supply mechanism 124. Further details on the operation of the tool 110 can be found, e.g., in the aforementioned '931 patent.

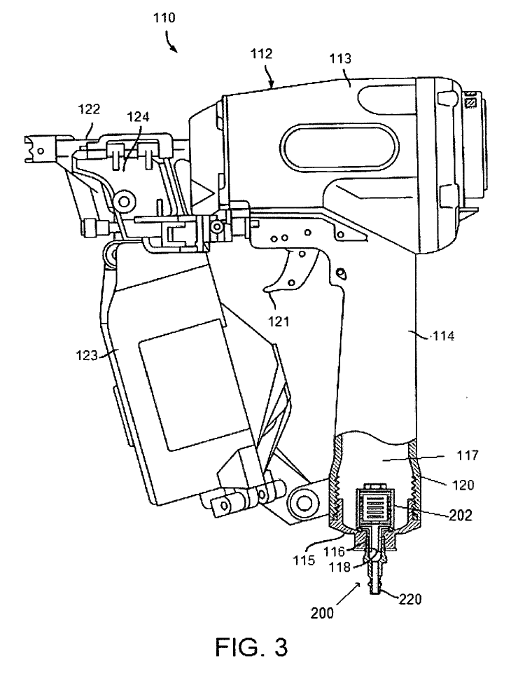

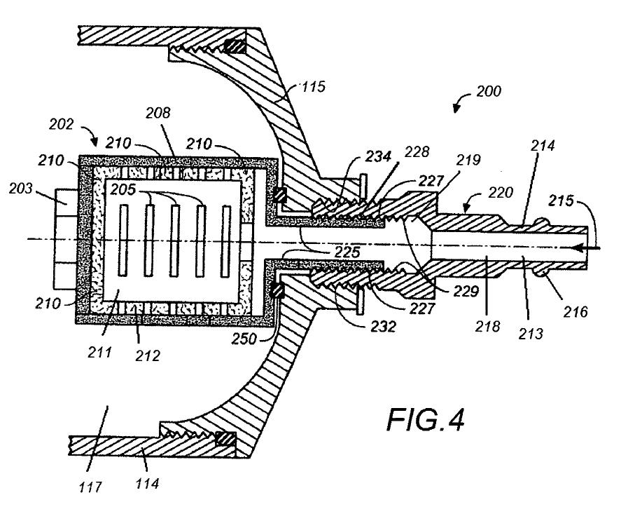

Referring to FIGS. 3 and 4, pneumatic tool 110 may be retrofitted with a filter assembly 200. Filter assembly 200 includes a retrofit connector 220 adapted to be received by the end cap 115 of the pneumatic tool 110 in place of hose connector 119, and a filter 202 connected to the retrofit connector 220 independent of the end cap 115 to filter the compressed gas. With reference to FIG. 4, connector 220 has a first mechanical connection, which may be in the form of internal female threads 229, and a second mechanical connection, which may be in the form of external male threads 227. External threads 227 are configured to mate with a third mechanical connection, which may be in the form of internal female threads 118 formed in end cap 115. Filter 202 includes a fourth mechanical connection, which may be in the form of external male threads 228 configured to mate with the internal threads 229 of the connector.

Connector 220 is generally cylindrical with an axial bore 213 therethrough and includes an end portion 214 that has a protrusion 216 to facilitate connection with a hose that extends from the air compressor (not shown). Bore 213 includes a small diameter portion 218 adjacent end portion 214 and a large diameter portion 219 adjacent end portion 217. Large diameter portion 219 includes the internal female threads 229 for attaching connector 220 to filter 202.

Filter 202 includes a filter casing 208 and a coaxial throat 225 with the male threads 228 that mate with the corresponding internal female threads 229 of connector 220. Filter 202 is, thus, coupled to connector 220 independent of end cap 115. In an implementation, filter 202 includes a hex fitting 203 that facilitates attaching filter 202 to connector 220. In one implementation, disposed between filter 202 and end cap 115 is an optional spring member, e.g., O-ring 250, that reduces the tendency of the filter from loosening during use. Filter casing 208 has an outer wall 211 that defines slots 205 therethrough and a hollow interior 212 that houses a filter media 210. Compressed gas flows through connector 220 (indicated by arrow 215), throat 225, and filter media 210, before exiting through slots 205 into inlet cavity 117.

Filter media 210 filters impurities, such as dirt and oil, from the compressed gas to avoid clogging the parts of the pneumatic tool 110. Filter media 210 may be any type or combination of filter materials commonly used for gas filtration such as, for example, sintered and/or porous semi-spherical polymer granule bounded by a sintered media, or fibrous or paper mesh and/or gauze. In one implementation, filter media 210 includes portions of coarse and fine filter media to provide multiple stages of filtration, e.g., a first stage that traps large particles and a second stage that traps smaller particles, to reduce clogging of the filter. For example, a coarse filter media may extract particles having a size, e.g., of approximately 40 microns or greater, and a fine filter media may extract particles having a size, e.g., of approximately 10 to 20 microns. In another implementation, the filter media 210 includes a single stage having filter media that has substantially constant filtration size. For example, the filter provides a filtration of particles having a size of, e.g., approximately 10 to approximately 40 microns or more. In yet another implementation, the filter is self-cleaning, such that upon disconnecting the pneumatic tool from the compressed gas supply, the compressed gas discharges in a reverse direction through the filter media, which purges much of the trapped particles from the filter media.

Filter assembly 200 is installed in pneumatic tool 110 that lacks a filter, as follows. End cap 115 of the pneumatic tool is removed and the existing connector 119 is removed from end cap 115. Retrofit connector 220 is attached to end cap 115 in place of connector 119 by threading male threaded portion 232 into female threaded portion 118 on end cap 115. Filter 202 is attached to connector 220 by threading throat 225 into female threaded portion 227. End cap 115 is then replaced on handle 114 of pneumatic tool 110.

The filter assembly 200 may be supplied as a kit for retrofitting existing pneumatic tools that lack a built-in air filter. The kit may include, e.g., air filter 202 of such a size and shape to fit inside the handle of most pneumatic power tools, and a connector 220 adapted to fit into the threaded aperture of a conventional end cap of a pneumatic tool. Optionally a plurality of different sized filters and connectors can be supplied. In addition, optionally a generic end cap to fit most pneumatic tools could be provided.

Numerous modifications may be made to the exemplary implementations described above. For example, one or more of the internal and external threads on the connector, male threads on the throat, and threads on the end cap may be replaced or supplemented by one or more other mechanical connections, such as, for example, a bayonet mechanism, a snap-fit, a frictional fit, a quick release, a spring-biased ball and detent, an adhesive, a hook and loop fastener, a set screw, and/or a Luer lock. The filter and/or the connector can have a non-cylindrical shape. The filter may be attached to the connector such that the filter is disposed exterior of the handle of the pneumatic tool. The connector and/or filter can be composed of any suitable material, e.g., metal or plastic. The steps for attaching the connector and filter may be performed in a different order, such as attaching the filter to the connector before attaching the connector to the end cap. These and other implementations are within the scope of the following claims.

What is claimed is:

1. A filter assembly for a pneumatic tool having an end cap configured to receive a connector for connecting the pneumatic tool to a source of compressed gas, the filter assembly comprising:
a retrofit connector adapted to be received by the end cap of the pneumatic tool in place of the connector; and
a filter connected to the retrofit connector independent of the end cap, the filter configured to filter the compressed gas received from the source.

2. The filter assembly of claim 1, wherein the retrofit connector has an external connection portion configured to connect the retrofit connector to the end cap.

3. The filter assembly of claim 2, wherein the external connection portion comprises external threads.

4. The filter assembly of claim 2, wherein the retrofit connector has an internal connection portion to which the filter is connected.

5. The filter assembly of claim 4, wherein the internal connection portion comprises internal threads.

6. The filter assembly of claim 1, wherein when the filter is connected to the retrofit connector and the retrofit connector is attached to the end cap, the filter is positioned substantially inside of the pneumatic tool.

7. The filter assembly of claim 1, wherein the filter comprises a filter disposed inside a casing.

8. The filter assembly of claim 7, wherein the filter further comprises a throat portion coupled to the casing, the throat portion being connected to the retrofit connector.

9. The filter assembly of claim 1, further comprising a spring member disposed between the filter and the end cap.

10. The filter assembly of claim 1, wherein the connector comprises an extension that extends from the end cap for attachment to a compressed air hose.

11. A filter assembly for a pneumatic tool having an end cap, comprising:
a connector configured to be attached to a source of compressed gas and to the end cap of the pneumatic tool, the connector having a first mechanical connection, and a second mechanical connection configured to mate with a third mechanical connection disposed on the end cap; and
a filter configured to filter the compressed gas, the filter including a fourth mechanical connection configured to mate with the first mechanical connection of the connector.

12. The filter assembly of claim 11, wherein each of the first and fourth mechanical connections comprise at least one of a threaded connection, a bayonet connection, a snap-fit connection, a frictional connection, a quick release connection, a spring-biased ball and detent connection, an adhesive connection, a hook-and-loop fastener, a set screw, and a Luer lock.

13. The filter assembly of claim 11, wherein each of the second and third mechanical connections comprise at least one of a threaded connection, a bayonet connection, a snap-fit connection, a frictional connection, a quick release connection, a spring-biased ball and detent connection, an adhesive connection, a hook-and-loop fastener, a set screw, and a Luer lock.

14. The filter assembly of claim 11, wherein the first mechanical connection is disposed on an inner surface of the connector and the second mechanical connection is disposed on an outer surface of the connector.

15. The filter assembly of claim 11, wherein the filter includes a filter media that comprises one or more of sintered semi-spherical polymer granule, porous semi-spherical polymer granule, fibrous mesh, paper mesh and gauze.

16. The filter assembly of claim 11, wherein the filter comprises a combination of coarse and fine filter media.

17. The filter assembly of claim 16, wherein the combination of course and fine filter media comprises particles having a size between approximately 10 microns and approximately 40 microns.

18. The filter assembly of claim 11, wherein the connector further comprises a fifth mechanical connection configured to be attached to a hose from the compressed gas source.

19. A pneumatic tool, comprising:
a housing containing a pneumatically driven engine;
a handle extending from the housing and including an inlet for delivering compressed air to the engine;
an end cap removably coupled to the handle and having an aperture therethrough in fluid communication with the inlet;
a connector configured to deliver compressed gas to the engine, the connector received in the aperture and having a first mechanical connection, and a second mechanical connection configured to mate with a third mechanical connection disposed on the end cap;
a filter configured to filter the compressed gas, the filter including a fourth mechanical connection configured to mate with the first mechanical connection of the connector;
a trigger adjacent to the handle;
a nosepiece coupled to the housing; and
a magazine for containing a plurality of fasteners, the magazine coupled to the nosepiece and to at least one of the handle and the housing,
wherein when the trigger is actuated, compressed air flows through the connector, the filter, and the inlet to actuate the engine, which drives one or more of the plurality of fasteners through the nosepiece.

20. A method of retrofitting a pneumatic tool, comprising:
removing an end cap of the pneumatic tool;
removing an existing connector from the end cap of the pneumatic tool;
attaching a filter assembly that includes a retrofit connector in communication with a filter to the end cap in place of the existing connector; and, replacing the end cap on the pneumatic tool.

21. The method of claim 20, wherein attaching the filter assembly comprises attaching the retrofit connector to the end cap in place of the existing connector and attaching the filter to the retrofit connector.
